(19) United States
(12) Patent Application Publication
(10) Pub. No.: US 2013/0078400 A1
(43) Pub. Date: Mar. 28, 2013

(54) MOLD FOR MANUFACTURING SLEEVE AND SLEEVE MANUFACTURED BY USING THE SAME

(71) Applicant: Young Tae KIM, Seoul (KR)

(72) Inventor: Young Tae KIM, Seoul (KR)

(73) Assignee: Samsung Electro-Mechanics Co., Ltd., Suwon (KR)

(21) Appl. No.: 13/589,328

(22) Filed: Aug. 20, 2012

(30) Foreign Application Priority Data
Sep. 22, 2011 (KR) 10-2011-0095653

(51) Int. Cl. B22F 3/12; B32B 1/08; B22F 5/12

(52) U.S. Cl. 428/34.1; 425/78; 419/5

(57) ABSTRACT

There are provided a mold for manufacturing a sleeve capable of improving product quality by preventing damage in an edge of a mold used for manufacturing a sintered type sleeve, and a sleeve manufactured by using the same. The mold includes: a housing mold having a hollow part formed therein, a closed lower end, and a pillar standing at a center thereof in order to form a shaft hole of a sleeve; and a pressing mold pressing sintering powder after the housing mold is filled with the sintering powder, thereby allowing the sintering powder to be sintered in a sleeve shape, wherein the pressing mold has an outer inclined surface formed along an edge portion of an outer diameter of a front end thereof and a step portion formed at an outermost portion of the outer inclined surface.

### CROSS-REFERENCE TO RELATED APPLICATIONS

This application claims the priority of Korean Patent Application No. 10-2011-0095653 filed on Sep. 22, 2011, in the Korean Intellectual Property Office, the disclosure of which is incorporated herein by reference.

### BACKGROUND OF THE INVENTION

1. Field of the Invention

The present invention relates to a mold for manufacturing a sleeve capable of improving product quality by preventing damage in an edge of a mold used for manufacturing a sintered type sleeve, and a sleeve manufactured by using the same.

2. Description of the Related Art

A hard disk drive (HDD), an information storage device, reads data stored on a disk or writes data to the disk using a read/write head.

The hard disk drive requires a disk-driving device capable of driving the disk. As the disk-driving device, a small-sized motor is used.

As the small-sized motor, a hydrodynamic bearing assembly has been used. A shaft, a rotating member of the hydrodynamic bearing assembly, and a sleeve, a fixed member thereof, include oil interposed therebetween, such that the shaft is supported by fluid pressure generated in the oil.

Here, as the sleeve used in the small-sized motor, there are provided a sintered sleeve and a processed sleeve. In order to increase price competitiveness of the motor, a sintered sleeve having a high oil content has mainly been used.

However, when the sintered sleeve is used, it contains a large amount of oil, such that a variation in an oil interface is increased due to thermal expansion of the oil. Thus, a sleeve housing enclosing an outer diameter of the sleeve in order to prevent leakage of the oil may be additionally provided.

Meanwhile, the sintered sleeve is manufactured in a sintering scheme by using a copper-iron alloy, iron or stainless steel powders as a sintered body, and distal ends of inner and outer diameters of edge portions of the sintered sleeve have a chamfer shape. However, in order to form this chamfered end, a mold having the same shape as the chamfered end needs to be formed. Sharp parts are formed at inner and outer diameters of end portions of the mold formed as described above and may be worn out and damaged due to repeated use thereof, such that burrs may be formed in the sintered sleeve.

### SUMMARY OF THE INVENTION

An object of the present invention is to form step portions in distal edges of chamfers provided at edge portions of a mold used for manufacturing a sintered sleeve to prevent abrasion or damage of the edge portions in spite of the repeated use thereof or impacts, thereby improving reliability of the sintered sleeve manufactured by the mold.

According to an aspect of the present invention, there is provided a mold for manufacturing a sleeve, the mold including: a housing mold having a hollow part formed therein, a closed lower end, and a pillar standing at a center thereof in order to form a shaft hole of a sleeve; and a pressing mold pressing sintering powder after the housing mold is filled with the sintering powder, thereby allowing the sintering powder to be sintered in a sleeve shape, wherein the pressing mold has an outer inclined surface formed along an edge portion of an outer diameter of a front end thereof and a step portion formed at an outermost portion of the outer inclined surface.

The pressing mold may have an inner inclined surface formed along an edge portion of an inner diameter of the front end thereof and a step portion formed at an innermost portion of the inner inclined surface.

The housing mold may have a cylindrical shape.

According to another aspect of the present invention, there is provided a method of manufacturing a sleeve including: filling a housing mold having a hollow part formed therein and a pillar standing at a center thereof in order to form a shaft hole, with sintering powder; pressing the sintering powder filled in the housing mold using a pressing mold; and removing the pressing mold to thereby detach a sleeve sintered in a predetermined shape from the housing mold.

The pressing mold may have an outer inclined surface formed along an edge portion of an outer diameter of a front end thereof and a step portion formed at an outermost portion of the outer inclined surface.

The pressing mold may have an inner inclined surface formed along an edge portion of an inner diameter of a front end thereof and a step portion formed at an innermost portion of the inner inclined surface.

The sintering powder may be formed of any one of iron (Fe), a copper (Cu)-iron (Fe) alloy, and stainless steel.

According to another aspect of the present invention, there is provided a sleeve including a shaft hole formed therein so as to allow a shaft to be inserted thereinto and to rotate, and an outer chamfer provided at an outer diameter of an edge portion thereof, the sleeve including: an outer step portion provided at an outermost portion of the outer chamfer.

The sleeve may further include: an inner chamfer provided at an inner diameter of the edge portion thereof; and an inner step portion provided at an innermost portion of the inner chamfer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a mold for manufacturing a sintered sleeve according to an embodiment of the present invention;

FIG. 2 is a cross-sectional view of a mold for manufacturing a sintered sleeve according to another embodiment of the present invention;

FIGS. 3A through 3C are views showing a method of manufacturing a sintered sleeve by using the mold for manufacturing a sintered sleeve according to the embodiment of the present invention;

FIGS. 4A and 4B are perspective views of a sintered sleeve manufactured by the mold for manufacturing a sintered sleeve according to the embodiment of the present invention; and

FIGS. 5A and 5B are cross-sectional views of the sintered sleeve shown in FIGS. 4A and 4B.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

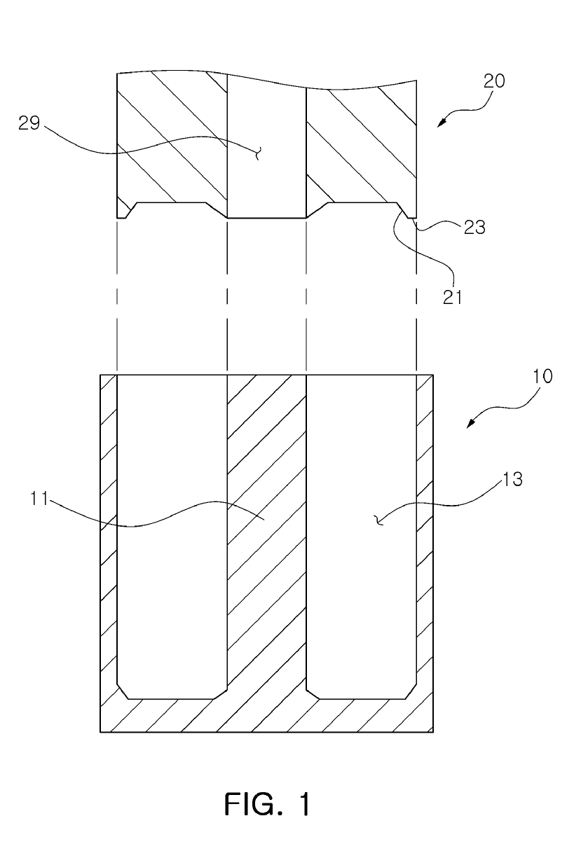

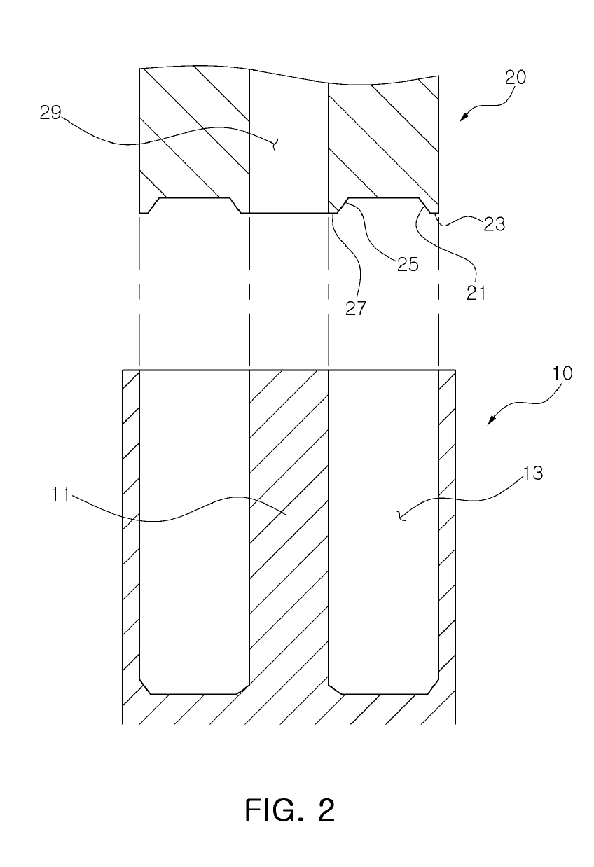

FIG. 1 is a cross-sectional view of a mold for manufacturing a sintered sleeve according to an embodiment of the present invention. FIG. 2 is a cross-sectional view of a mold for manufacturing a sintered sleeve according to another embodiment of the present invention.

Referring to FIGS. 1 and 2, the mold for manufacturing a sintered sleeve according to the embodiment of the present invention may include a housing mold 10 and a pressing mold 20.

The housing mold 10, which is a housing filled with powder used for molding, may have a hollow part 13 formed therein, a closed lower end, and a pillar 11 standing at the center thereof in order to form a shaft hole of a sleeve. An upper end of the housing mold 10 may be opened such that the pressing mold 20 to be described below may be inserted thereinto. The hollow part 13 may be filled with sintering powder formed of any one of iron (Fe), a copper (Cu)-iron (Fe) alloy, and stainless steel.

Generally, a bottom surface of the interior of the housing mold 10 may have a shape corresponding to that of a sleeve to be molded and include chamfers formed at edge portions of inner and outer diameters thereof, each of the chamfers having a step portion.

The pressing mold 20 is a means capable of pressing sintering powder after the hollow part of the housing mold 10 is filled with the sintering powder. That is, when it is assumed that work is performed in a state in which the housing mold 10 is disposed on a horizontal surface, the pressing mold 20 is inserted into an open portion of the upper end of the housing mold 10, after the hollow part of the housing mold 10 is filled with the sintering powder, thereby pressing the sintering powder downwardly at high pressure.

Therefore, a front end of the pressing mold 20 needs to have a shape corresponding to that of an upper end or a lower end of the sleeve to be molded. According to the related art, a sleeve has chamfers (inclined parts) provided at inner and outer diameters of edge portions thereof, such that the pressing mold according to the related art has inclined surfaces provided at inner and outer diameters of a front end. However, these inclined surfaces are easily worn out or damaged due to repeated use or external impacts, such that the pressing mold may not accurately perform its function.

Therefore, according to the embodiment of the present invention, the pressing mold 20 has the inclined surfaces provided at the inner and outer diameters of the front end and step portions are formed at edge portions of the inclined surfaces, thereby preventing damage due to external impacts or abrasion due to repeated use.

More specifically, the pressing mold 20 may have an outer inclined surface 21 formed at the outer diameter of the front end thereof and an inner inclined surface 25 formed at the inner diameter of the front end thereof, the inner diameter of the front end being provided with a pillar hole 29 in order that the pillar 11 of the housing mold 10 may be inserted thereinto.

In the case of the mold for manufacturing a sintered sleeve according to an embodiment of the present invention, a step portion 23 is provided only at the outer inclined surface 21 (See FIG. 1), and in the case of the mold for manufacturing a sintered sleeve according to another embodiment of the present invention, a step portion 27 is also provided at the inner inclined surface 25 (See FIG. 2), as well as the step portion 23 provided at the outer inclined surface 21.

In addition, although not shown, the housing mold 10 or the pressing mold 20 may include a heating unit applying heat or the pressing mold 20 may include a heating unit applying heat to the sintering powder.

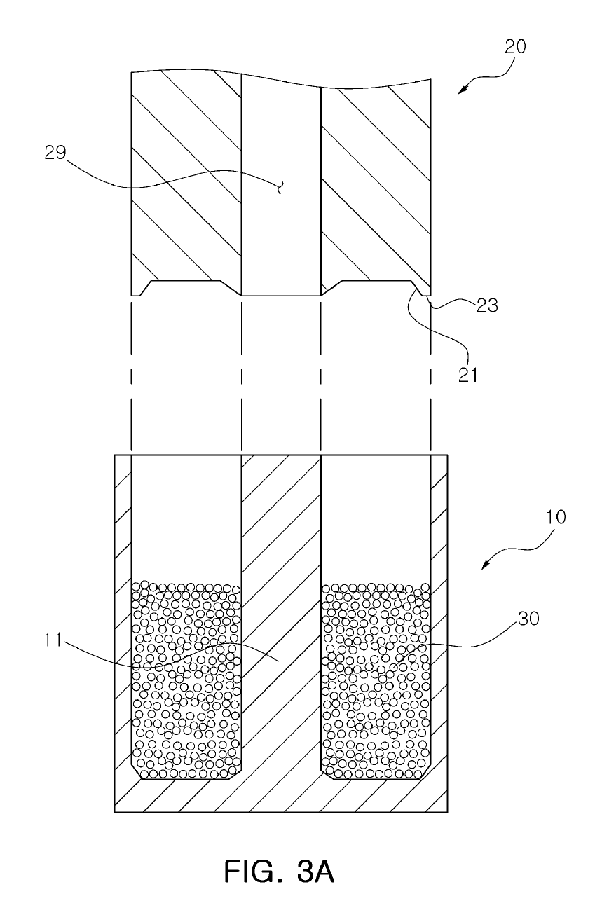

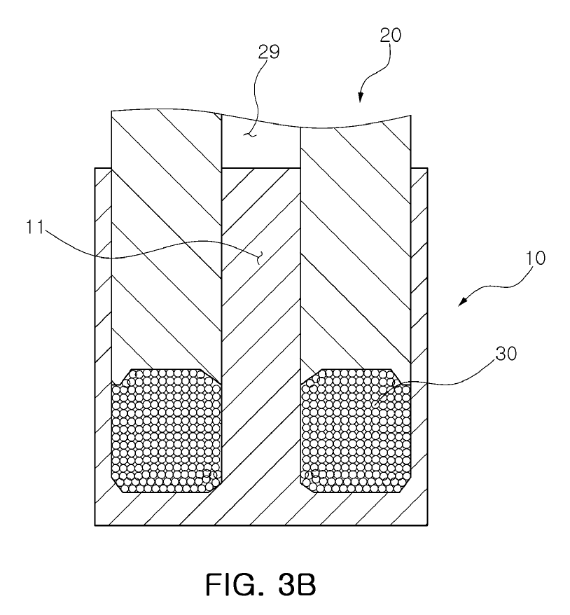

FIGS. 3A through 3C are views showing a method of manufacturing a sintered sleeve by using the mold for manufacturing a sintered sleeve according to the embodiment of the present invention.

Referring to FIGS. 3A-3C, the method of manufacturing a sintered sleeve by using the mold for manufacturing a sintered sleeve according to the embodiment of the present invention may include (a) filling housing mold 10 with sintering powder 30, (b) pressing the sintering powder 30 filled in the housing mold 10 using a pressing mold 20, and (c) detaching the molds from each other to thereby complete the sintered sleeve.

The pressing mold 20 used in the method for manufacturing a sintered sleeve may have the outer inclined surface 21 formed along the edge portion of the outer diameter of the front end thereof, and the step portion 23 is formed at an outermost portion of the outer inclined surface 21. In addition, the pressing mold 20 may have the inner inclined surface 25 formed along the edge portion of the inner diameter of the front end thereof and the step portion 27 is formed at an innermost portion of the inner inclined surface 25.

In addition, the sintering powder may be formed of any one of iron (Fe), a copper (Cu)-iron (Fe) alloy, and stainless steel.

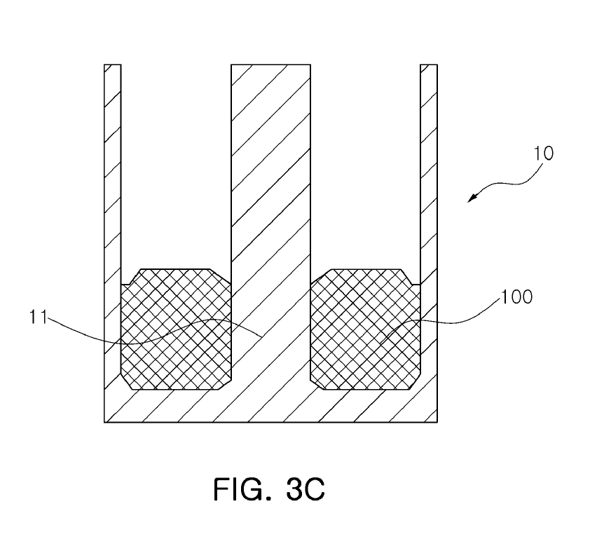

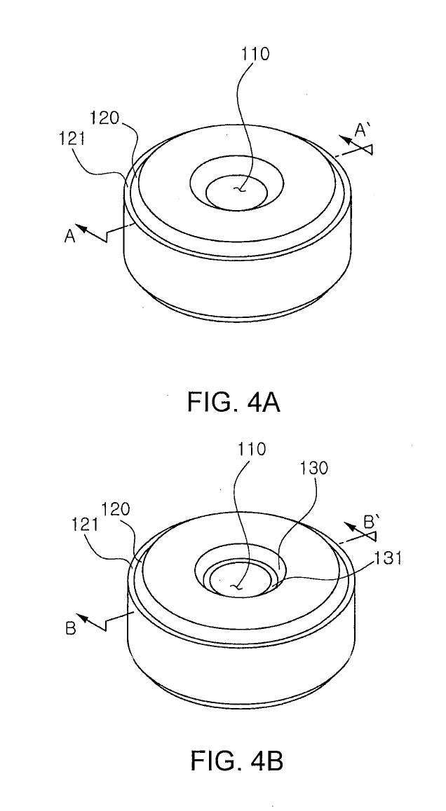

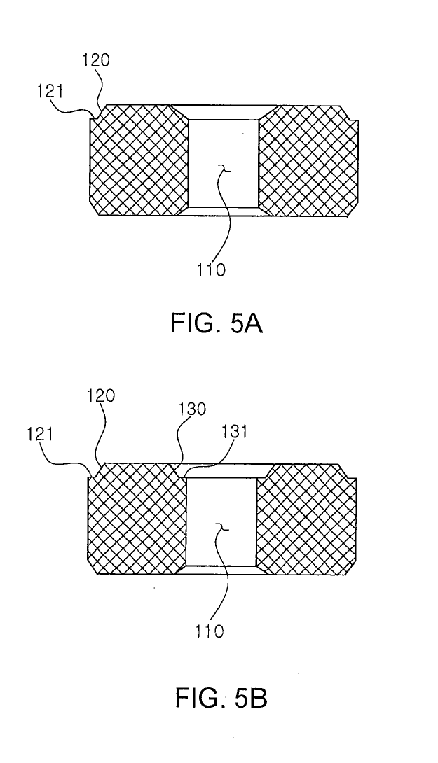

sleeve manufactured by the mold for manufacturing a sintered sleeve according to the embodiment of the present invention. FIGS. 5A and 5B are cross-sectional views of the sintered sleeve shown in FIGS. 4A and 4B.

Referring to FIGS. 4A, 4B, 5A, and 5B, the sintered sleeve according to the embodiment of the present invention, a sleeve 100 including a shaft hole 110 formed therein so as to allow a shaft to be inserted thereinto and to rotate, and an outer chamfer 120 provided at an outer diameter of an edge portion thereof, may include an outer step portion 121 provided at an outermost portion of the outer chamfer 120.

In addition, the sintered sleeve 100 according to another embodiment of the present invention may include an inner chamfer 130 provided at an inner diameter of the edge portion thereof and an inner step portion 131 provided at an innermost portion of the inner chamfer 130, in addition to components of the sintered sleeve 100 according to the foregoing embodiment of the present invention.

As set forth above, with the mold for manufacturing a sintered sleeve according to embodiments of the present invention, the step portion is formed at the distal edge of the chamfer provided at the edge portion of the mold to prevent abrasion or damage of the edge portion in spite of repeated use or other impacts, whereby the sleeve may be molded to have an accurate shape in which a burr, or the like, is not generated.

While the present invention has been shown and described in connection with the embodiments, it will be apparent to those skilled in the art that modifications and variations can be made without departing from the spirit and scope of the invention as defined by the appended claims.

What is claimed is:

1. A mold for manufacturing a sleeve, the mold comprising:
a housing mold having a hollow part formed therein, a closed lower end, and a pillar standing at a center thereof in order to form a shaft hole of a sleeve; and
a pressing mold pressing sintering powder after the housing mold is filled with the sintering powder, thereby allowing the sintering powder to be sintered in a sleeve shape,
wherein the pressing mold has an outer inclined surface formed along an edge portion of an outer diameter of a front end thereof and a step portion formed at an outermost portion of the outer inclined surface.

2. The mold of claim 1, wherein the pressing mold has an inner inclined surface formed along an edge portion of an inner diameter of the front end thereof and a step portion formed at an innermost portion of the inner inclined surface.

3. The mold of claim 1, wherein the housing mold has a cylindrical shape.

4. A method of manufacturing a sleeve comprising:
filling a housing mold having a hollow part formed therein and a pillar standing at a center thereof in order to form a shaft hole, with sintering powder;
pressing the sintering powder filled in the housing mold using a pressing mold; and
removing the pressing mold to detach a sleeve sintered in a predetermined shape from the housing mold.

5. The method of claim 4, wherein the pressing mold has an outer inclined surface formed along an edge portion of an outer diameter of a front end thereof and a step portion formed at an outermost portion of the outer inclined surface.

6. The method of claim 4, wherein the pressing mold has an inner inclined surface formed along an edge portion of an inner diameter of a front end thereof and a step portion formed at an innermost portion of the inner inclined surface.

7. The method of claim 4, wherein the sintering powder is formed of anyone of iron (Fe), a copper (Cu)-iron (Fe) alloy, and stainless steel.

8. A sleeve including a shaft hole formed therein so as to allow a shaft to be inserted thereinto and to rotate, and an outer chamfer provided at an outer diameter of an edge portion thereof, the sleeve comprising:
an outer step portion provided at an outermost portion of the outer chamfer.

9. The sleeve of claim 8, further comprising:
an inner chamfer provided at an inner diameter of the edge portion thereof; and
an inner step portion provided at an innermost portion of the inner chamfer.
